(19) United States
(12) Patent Application Publication
(10) Pub. No.: US 2020/0056732 A1
(43) Pub. Date: Feb. 20, 2020

(54) Quick Release Connector

(71) Applicant: Bossomoor Trading Co., Ltd., Xiushui Township (TW)

(72) Inventor: Kuei-Sen Pai, Xiushui Township (TW)

(21) Appl. No.: 16/104,981

(22) Filed: Aug. 20, 2018

(51) Int. Cl. F16L 37/23; F16L 37/40

(52) U.S. Cl. CPC F16L 37/23; F16L 37/40

(57) ABSTRACT

A quick release connector includes a connector body provided with a through hole and a plurality of receiving holes connected to the through hole, a plurality of positioning balls movably mounted in the receiving holes and partially extending into the through hole, a movable ring mounted on the connector body, an elastic member biased between the connector body and the movable ring, and an outer sleeve movably mounted on the connector body and provided with a plurality of receiving recesses. When the outer sleeve pushes the movable ring, the receiving recesses of the outer sleeve align with the receiving holes of the connector body, and the positioning balls are detached from the through hole of the connector body and are moved into the receiving recesses of the outer sleeve.

### BACKGROUND OF THE INVENTION

### 1. Field of the Invention

The present invention relates to a connector or coupling and, more particularly, to a quick release connector.

### 2. Description of the Related Art

A quick release connector is used to connect a joint. When the joint is inserted into the quick release connector, a ball in the quick release connector is pushed and moved to lock the joint. On the contrary, an outer sleeve of the quick release connector is pushed to release the ball and to unlock the joint so that the joint is detached from the quick release connector. A conventional quick release connector in accordance with the prior art shown in FIG. 7 comprises a positioning tube 5, a push ring 55, an elastic member 56, two circular rods 53, two balls 54 and an outer ring 6. The positioning tube 5 is provided with two oblique slots 51 and two through holes 52. The circular rods 53 are movably mounted in the oblique slots 51 of the positioning tube 5. The balls 54 are mounted in the through holes 52 of the positioning tube 5. The push ring 55 is movably mounted on the positioning tube 5. The elastic member 56 is mounted on the positioning tube 5 and pushes the push ring 55 which pushes the circular rods 53 upward and presses the balls 54 inward to clamp a joint which is inserted into the positioning tube 5. The outer ring 6 is mounted on the positioning tube 5 and rests on the push ring 55 so that the push ring 55 is moved in concert with the outer ring 6. Thus, the outer ring 6 pushes the push ring 55 downward to release the circular rods 53 and the balls 54 so that the joint is unlocked and detached from the positioning tube 5. However, the oblique slots 51 are located at two sides of the positioning tube 5 to reduce the structural strength largely, so that the connection of the positioning tube 5 and the joint is easily deformed or broken, thereby forming a gap or crack between the quick release connector and the joint.

### BRIEF SUMMARY OF THE INVENTION

In accordance with the present invention, there is provided a quick release connector comprising a connector body having an interior provided with a through hole and having a periphery provided with a plurality of receiving holes connected to the through hole, a plurality of positioning balls mounted in the receiving holes of the connector body, a movable ring mounted on the connector body, an elastic member mounted on the connector body, and an outer sleeve mounted on the connector body. The connector body includes a first end and a second end. Each of the receiving holes of the connector body is provided with at least one limit portion which reduces a diameter of a connection of each of the receiving holes and the through hole, with the diameter of a connection of each of the receiving holes and the through hole being smaller than that of each of the positioning balls. The positioning balls are movable in the receiving holes of the connector body and partially extend into the through hole of the connector body. The movable ring is movable on the connector body and has an inner rim pushing the positioning balls. The inner rim of the movable ring has an outline corresponding to that of an outer rim of the first end of the connector body. The elastic member is biased between the connector body and the movable ring to push the movable ring toward the positioning balls. The outer sleeve is provided with at least one pushing portion abutting the movable ring and has an interior provided with a plurality of receiving recesses corresponding to the positioning balls. When the outer sleeve pushes and moves the movable ring, the receiving recesses of the outer sleeve are moved to align with the receiving holes of the connector body, and the positioning balls are detached from the through hole of the connector body and are movable in the receiving holes of the connector body and the receiving recesses of the outer sleeve. When the elastic member pushes and moves the movable ring, the positioning balls are detached from the receiving recesses of the outer sleeve and are positioned in the receiving holes of the connector body.

According to the primary advantage of the present invention, the positioning balls are positioned in the receiving holes of the connector body during the assembly process, and the receiving recesses of the outer sleeve are moved to align with the receiving holes of the connector body when the outer sleeve is pushed downward, so that the joint and the quick release connector are assembled and locked easily and quickly.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a quick release connector in accordance with the preferred embodiment of the present invention.

FIG. 2 is an exploded perspective view of the quick release connector in accordance with the preferred embodiment of the present invention.

FIG. 3 is a cross-sectional view of the quick release connector in accordance with the preferred embodiment of the present invention.

FIG. 4 is another cross-sectional view of the quick release connector in accordance with the preferred embodiment of the present invention.

FIG. 5 is a schematic operational view of the quick release connector as shown in FIG. 4.

FIG. 6 is a schematic operational view of the quick release connector as shown in FIG. 5.

FIG. 7 is an exploded perspective view of a conventional quick release connector in accordance with the prior art.

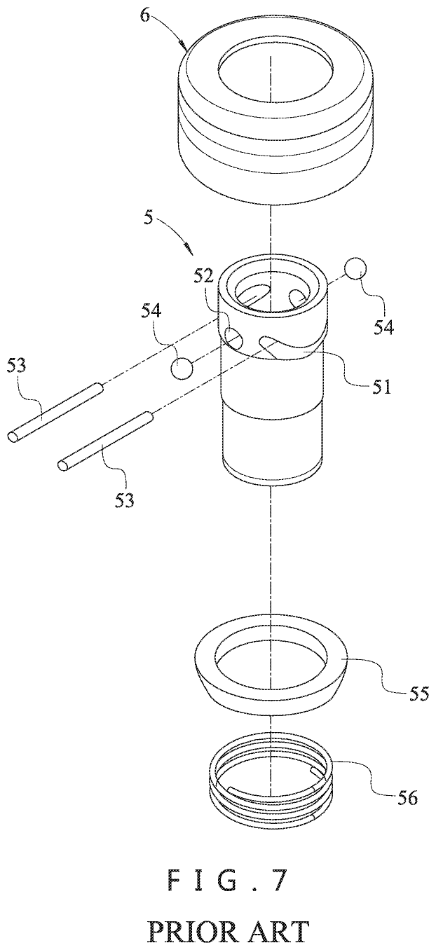

### DETAILED DESCRIPTION OF THE INVENTION

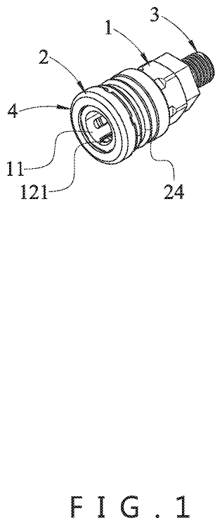

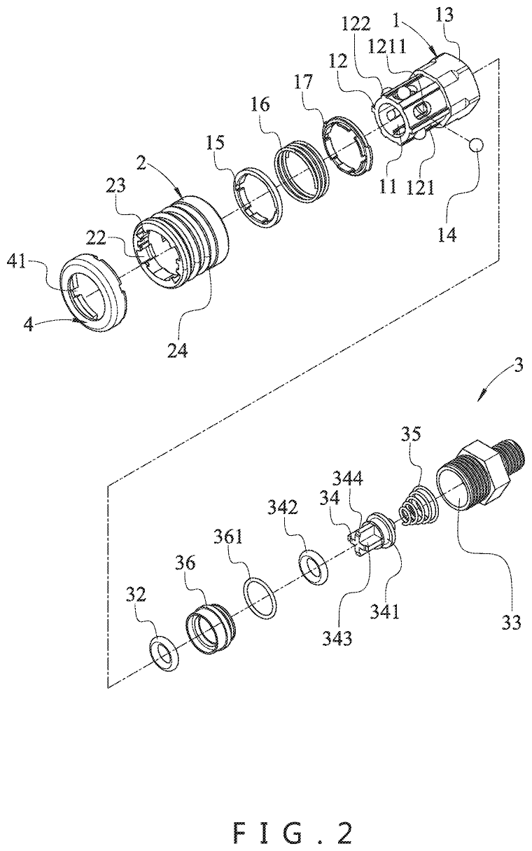

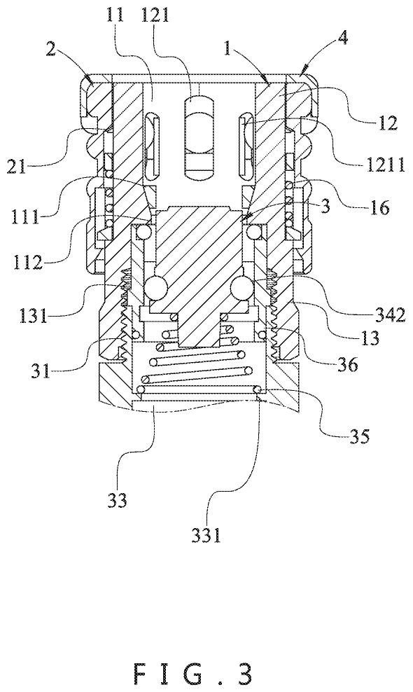

Referring to FIGS. 1-6, a quick release connector in accordance with the preferred embodiment of the present invention comprises a connector body 1 having an interior provided with a through hole 11 and having a periphery provided with a plurality of receiving holes 121 connected to the through hole 11, a plurality of positioning balls 14 mounted in the receiving holes 121 of the connector body 1, a movable ring 15 mounted on the connector body 1, an elastic member 16 mounted on the connector body 1, and an outer sleeve 2 mounted on the connector body 1.

The connector body 1 includes a first end 12 functioning as an insertion portion and a second end 13 functioning as a pivot portion. The receiving holes 121 are formed in the first end 12 of the connector body 1. Each of the receiving holes 121 of the connector body 1 is provided with at least one limit portion 1211 which reduces a diameter of a connection of each of the receiving holes 121 and the through hole 11, with the diameter of a connection of each of the receiving holes 121 and the through hole 11 being smaller than that of each of the positioning balls 14.

The positioning balls 14 are movable upward and downward in the receiving holes 121 of the connector body 1 and partially extend into the through hole 11 of the connector body 1.

The movable ring 15 is movable upward and downward on the connector body 1 and has an inner rim pushing the positioning balls 14. The inner rim of the movable ring 15 has an outline corresponding to that of an outer rim of the first end 12 of the connector body 1.

The elastic member 16 is biased between the connector body 1 and the movable ring 15 to push the movable ring 15 toward the positioning balls 14.

The outer sleeve 2 is provided with at least one pushing portion 21 abutting the movable ring 15 and has an interior provided with a plurality of receiving recesses 22 corresponding to the positioning balls 14.

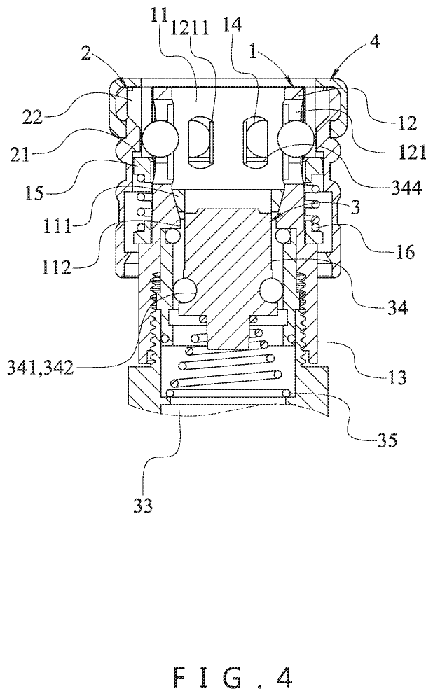

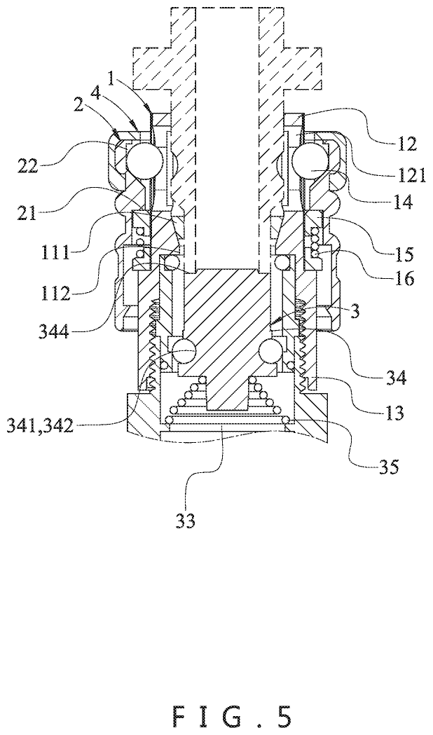

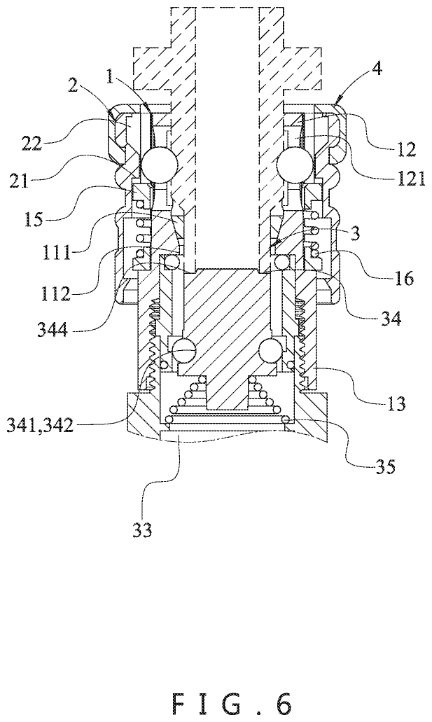

In practice, when the outer sleeve 2 pushes the movable ring 15 to move downward, the receiving recesses 22 of the outer sleeve 2 are moved to align with the receiving holes 121 of the connector body 1 as shown in FIG. 5, and the positioning balls 14 are detached from the through hole 11 of the connector body 1 and are movable in the receiving holes 121 of the connector body 1 and the receiving recesses 22 of the outer sleeve 2. On the contrary, when the elastic member 16 pushes the movable ring 15 to move upward, the positioning balls 14 are detached from the receiving recesses 22 of the outer sleeve 2 and are positioned in the receiving holes 121 of the connector body 1 as shown in FIGS. 4 and 6.

In the preferred embodiment of the present invention, a retaining ring 17 is secured on the connector body 1, and the elastic member 16 is biased between the retaining ring 17 and the movable ring 15.

In the preferred embodiment of the present invention, a block valve 3 is mounted on the second end 13 of the connector body 1. The second end 13 of the connector body 1 is provided with an internal thread 131 located in the through hole 11, and the block valve 3 is provided with an external thread 31 screwed into the internal thread 131 of the connector body 1.

In the preferred embodiment of the present invention, an O-ring 32 is mounted on an upper end of the external thread 31 of the block valve 3 and rests on an upper end of the internal thread 131 of the connector body 1.

In the preferred embodiment of the present invention, the block valve 3 has an interior provided with a perforation 33 connected to the through hole 11 of the connector body 1 and provided with a resting flange 331 located in the perforation 33. A blocking element 34 is movably mounted in the perforation 33 of the block valve 3. An elastic element 35 is mounted in the perforation 33 of the block valve 3 and biased between the blocking element 34 and the resting flange 331 of the block valve 3 to push the blocking element 34 upward.

In the preferred embodiment of the present invention, a guide ring 111 is secured in the through hole 11 of the connector body 1 and has an outer rim closely fitted into the through hole 11 of the connector body 1. Thus, when a joint is inserted into the through hole 11 of the connector body 1, the guide ring 111 is in close contact with the joint. The guide ring 111 has an inner diameter corresponding to an outer diameter of the blocking element 34.

In the preferred embodiment of the present invention, the blocking element 34 has a periphery provided with an annular groove 341, and a stop ring 342 is mounted in the annular groove 341 of the blocking element 34. The connector body 1 is provided with a stop portion 112 located in the through hole 11. Thus, when the blocking element 34 is pushed upward, the stop ring 342 presses the stop portion 112 of the connector body 1 to interrupt connection of the through hole 11 of the connector body 1 and the perforation 33 of the block valve 3.

In the preferred embodiment of the present invention, the blocking element 34 is provided with a plurality of guiding channels 343 and has an upper end provided with a plurality of fitting openings 344. Thus, when the joint is inserted into the through hole 11 of the connector body 1, one end of the joint is locked into the fitting openings 344 of the blocking element 34, and an aperture of the joint is connected to the perforation 33 of the block valve 3 through the guiding channels 343 of the blocking element 34. At this time, the guide ring 111 isolates the through hole 11 of the connector body 1, so that the aperture of the joint is not connected to the through hole 11 of the connector body 1.

In the preferred embodiment of the present invention, the connector body 1 has an outer face provided with a plurality of rails 122, and the outer sleeve 2 has an inner face provided with a plurality of slideways 23 mounted on the rails 122 of the connector body 1.

In the preferred embodiment of the present invention, the outer sleeve 2 has an outer face provided with a plurality of annular antiskid grooves 24 to facilitate operation of the outer sleeve 2. A cover 4 is mounted on the outer sleeve 2 and closes the receiving recesses 22 of the outer sleeve 2 to stop and prevent the positioning balls 14 from being detached from the receiving recesses 22 of the outer sleeve 2. The cover 4 is provided with an aperture 41 connected to the through hole 11 of the connector body 1.

In the preferred embodiment of the present invention, a guiding member 36 is mounted on the upper end of the block valve 3 and surrounds the blocking element 34. The guiding member 36 has an upper end corresponding to the through hole 11 of the connector body 1 and a lower corresponding to the perforation 33 of the block valve 3, so that the through hole 11 of the connector body 1 and the perforation 33 of the block valve 3 are connected through the guiding member 36. A seal ring 361 is mounted on the lower end of the guiding member 36 and closely fitted in the perforation 33 of the block valve 3 to provide an air-tight effect between the guiding member 36 and the perforation 33 of the block valve 3.

In operation, referring to FIGS. 5 and 6 with reference to FIGS. 1-4, when the outer sleeve 2 is forced to push the movable ring 15, the movable ring 15 is moved to detach from the positioning balls 14, and the elastic member 16 is compressed to store a restoring force. When the receiving recesses 22 of the outer sleeve 2 are moved to align with the receiving holes 121 of the connector body 1 as shown in FIG. 5, the positioning balls 14 are detached from the through hole 11 of the connector body 1 and are moved from the receiving holes 121 of the connector body 1 into the receiving recesses 22 of the outer sleeve 2. In such a manner, the joint is inserted into the through hole 11 of the connector body 1 and fitted in the fitting openings 344 of the blocking element 34. After the outer sleeve 2 is released, the movable ring 15 is pushed by the restoring force of the elastic member 16, so that the outer sleeve 2 and the movable ring 15 are moved and returned to the original position as shown in FIG. 6. At this time, the positioning balls 14 are detached from the receiving recesses 22 of the outer sleeve 2. In such a manner, the positioning balls 14 are pressed by the movable ring 15 and are moved from the receiving holes 121 into the through hole 11 of the connector body 1 to press the joint. Thus, the positioning balls 14 are pressed by the movable ring 15 and are positioned in the receiving holes 121 of the connector body 1 to lock the joint.

Accordingly, the positioning balls 14 are positioned in the receiving holes 121 of the connector body 1 during the assembly process, and the receiving recesses 22 of the outer sleeve 2 are moved to align with the receiving holes 121 of the connector body 1 when the outer sleeve 2 is pushed downward, so that the joint and the quick release connector are assembled and locked easily and quickly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A quick release connector comprising:
a connector body having an interior provided with a through hole and having a periphery provided with a plurality of receiving holes connected to the through hole;
a plurality of positioning balls mounted in the receiving holes of the connector body;
a movable ring mounted on the connector body;
an elastic member mounted on the connector body; and
an outer sleeve mounted on the connector body;
wherein:
the connector body includes a first end and a second end;
each of the receiving holes of the connector body is provided with at least one limit portion which reduces a diameter of a connection of each of the receiving holes and the through hole, with the diameter of a connection of each of the receiving holes and the through hole being smaller than that of each of the positioning balls;
the positioning balls are movable in the receiving holes of the connector body and partially extend into the through hole of the connector body;
the movable ring is movable on the connector body and has an inner rim pushing the positioning balls;
the inner rim of the movable ring has an outline corresponding to that of an outer rim of the first end of the connector body;
the elastic member is biased between the connector body and the movable ring to push the movable ring toward the positioning balls;
the outer sleeve is provided with at least one pushing portion abutting the movable ring and has an interior provided with a plurality of receiving recesses corresponding to the positioning balls;
when the outer sleeve pushes and moves the movable ring, the receiving recesses of the outer sleeve are moved to align with the receiving holes of the connector body, and the positioning balls are detached from the through hole of the connector body and are movable in the receiving holes of the connector body and the receiving recesses of the outer sleeve; and
when the elastic member pushes and moves the movable ring, the positioning balls are detached from the receiving recesses of the outer sleeve and are positioned in the receiving holes of the connector body.

2. The quick release connector of claim 1, wherein a retaining ring is secured on the connector body, and the elastic member is biased between the retaining ring and the movable ring.

3. The quick release connector of claim 1, wherein:
a block valve is mounted on the second end of the connector body;
the second end of the connector body is provided with an internal thread located in the through hole; and
the block valve is provided with an external thread screwed into the internal thread of the connector body.

4. The quick release connector of claim 3, wherein an O-ring is mounted on an upper end of the external thread of the block valve and rests on an upper end of the internal thread of the connector body.

5. The quick release connector of claim 3, wherein:
the block valve has an interior provided with a perforation connected to the through hole of the connector body and provided with a resting flange located in the perforation;
a blocking element is movably mounted in the perforation of the block valve; and
an elastic element is mounted in the perforation of the block valve and biased between the blocking element and the resting flange of the block valve to push the blocking element.

6. The quick release connector of claim 5, wherein a guide ring is secured in the through hole of the connector body and has an outer rim closely fitted into the through hole of the connector body.

7. The quick release connector of claim 5, wherein:
the blocking element has a periphery provided with an annular groove;
a stop ring is mounted in the annular groove of the blocking element;
the connector body is provided with a stop portion located in the through hole; and
when the blocking element is pushed, the stop ring presses the stop portion of the connector body to interrupt connection of the through hole of the connector body and the perforation of the block valve.

8. The quick release connector of claim 7, wherein the blocking element is provided with a plurality of guiding channels and has an upper end provided with a plurality of fitting openings.

9. The quick release connector of claim 1, wherein the connector body has an outer face provided with a plurality of rails, and the outer sleeve has an inner face provided with a plurality of slideways mounted on the rails of the connector body.

10. The quick release connector of claim 1, wherein:
the outer sleeve has an outer face provided with a plurality of annular antiskid grooves;
a cover is mounted on the outer sleeve and closes the receiving recesses of the outer sleeve; and
the cover is provided with an aperture connected to the through hole of the connector body.
